(19) United States
(12) Patent Application Publication
(10) Pub. No.: US 2014/0242381 A1
(43) Pub. Date: Aug. 28, 2014

(54) IR REFLECTIVE MULTILAYER STRUCTURE AND METHOD FOR MANUFACTURING THE SAME

(71) Applicant: INDUSTRIAL TECHNOLOGY RESEARCH INSTITUTE, Hsinchu (TW)

(72) Inventors: Huai-Kuang FU, Taichung City (TW); Sung-Jeng JONG, Hsinchu City (TW); Jer-Young CHEN, Hsinchu City (TW); Yih-Her CHANG, Hsin Chu County (TW); Pao-Tang CHUNG, Hsinchu City (TW)

(21) Appl. No.: 13/920,885

(22) Filed: Jun. 18, 2013

(30) Foreign Application Priority Data
Dec. 17, 2012 (TW) 101147736

(51) Int. Cl. C03C 17/34

(52) U.S. Cl. CPC C03C 17/3417; C03C 2217/73
USPC 428/336; 428/448; 427/226; 428/696; 428/428; 428/446

(57) ABSTRACT

The disclosure provides an IR reflective multilayer structure, including a transparent substrate, a barrier layer disposed on the transparent substrate, wherein the barrier layer includes tungsten oxide-containing silicon dioxide, tungsten oxide-containing titanium dioxide, tungsten oxide-containing aluminium oxide or combinations thereof, and a heat shielding layer composed of a composite tungsten oxide, represented by Formula (I): MₓWO_{3-y}A_{y}, wherein M is an alkali metal element or alkaline earth metal element, W is tungsten, O is oxygen, A is halogen, and 0<x≦1, 0<y≦0.5. The disclosure also provides a method for manufacturing an IR reflective multilayer structure.

### CROSS REFERENCE TO RELATED APPLICATIONS

This application claims priority of Taiwan Patent Application No. 101147736, filed on Dec. 17, 2012, the entirety of which is incorporated by reference herein.

### BACKGROUND

1. Technical Field

The present disclosure relates to an infrared (IR) reflective multilayer structure, and in particular, to an infrared (IR) reflective multilayer structure and a method for manufacturing the same.

2. Description of the Related Art

A general commercially available heat shielding glass is a low radiation glass with a single layer or double layer of silver, formed by sputtering a protective film thereon under a vacuum environment to maintain glass stability. For example, a low-e glass is formed by depositing zinc oxide (ZnO) or silicon nitride (Si₃N₄) on a substrate by sputtering. However, since the equipment for the vacuum sputtering process is expensive and a complicated multilayer deposition process is required, the manufacturing cost of the low-e glass is relatively high,

On the other hand, a composite tungsten oxide film is a well known heat shielding material with IR reflectivity. A heat shielding glass with high transparency and IR reflectivity containing a single heat shielding layer can be produced by a simple wet coating process and a thermal pyrolysis process. However, when the composite tungsten oxide (MₓWO_{3-y}A_{y}) precursor solution is coated onto a general glass, sodium migration occurs at temperatures of 500-600° C. when pyrolysis occurs, thus, destroying the insulative lattice structure of the composite tungsten oxide (MₓWO_{3-y}A_{y}) and reducing heat shielding ability. Therefore, composite tungsten oxide (MₓWO_{3-y}A_{y}) is not suitable for use with general glass. For tempered glass, expensive equipment is needed for a required sputtering process. Also, tempered glass loses its strength after a thermal treatment is applied thereto, so the simple wet coating process and thermal pyrolysis are not suitable for use with tempered glass.

### SUMMARY

According to an embodiment, the disclosure provides an infrared (IR) reflective multilayer structure, comprising a transparent substrate, a barrier layer disposed on the transparent substrate, wherein the barrier layer comprises silicon dioxide containing tungsten oxide, titanium dioxide, aluminum oxide, or a combination thereof, and a heat shielding layer disposed on the barrier layer, wherein the heat shielding layer is composed of a composite tungsten oxide, represented by Formula (I):

MₓWO_{3-y}A_{y} (I)

wherein M is an alkali or alkaline earth metal element, W is tungsten, O is oxygen, A is a halogen element, and 0<x≦1, 0<y≦0.5.

In accordance with another embodiment, the disclosure also provides a method for manufacturing an infrared (IR) reflective multilayer structure, comprising performing a first wet coating process by coating a tungsten oxide-containing silicon dioxide solution, a tungsten oxide-containing titanium dioxide solution, or an tungsten oxide-containing aluminum oxide solution on a transparent substrate, and then sintering the coated substrate to form a barrier layer thereon; providing a solution of a composite tungsten oxide precursor, and adjusting the pH value of the solution to obtain a transparent precursor solution; performing a second wet coating process by coating the transparent precursor solution on the barrier layer; and performing a thermal process under a reducing gas atmosphere to strengthen the transparent substrate, and simultaneously pyrolyze the solution to form a heat shielding layer.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 is a schematic view of an infrared (IR) reflective multilayer structure according to an embodiment.

FIG. 2 illustrates the infrared (IR) transmission of a multilayer structure having and not having a coated barrier layer according to an embodiment.

FIG. 3 illustrates the infrared (M) transmission of a multilayer structure with a composite tungsten oxide coated onto different substrates.

FIG. 4A illustrates the infrared (IR) transmission of a multilayer structure with a heat shielding layer coated onto a general glass in the absent of a barrier layer.

FIG. 4B illustrates the infrared (IR) reflectivity of a multilayer structure with a heat shielding layer coated onto a general glass in the absent of a barrier layer for different reducing times.

FIG. 5A illustrates the infrared (IR) transmission of a multilayer structure with a heat shielding layer and a barrier layer coated onto a general glass at different sintering temperature.

FIG. 5B illustrates the infrared (IR) reflectivity of a multilayer structure with a heat shielding layer and a barrier layer coated onto a general glass at different sintering temperature.

FIG. 6 illustrates the infrared (IR) transmission of a multilayer structure with a transparent layer coated onto the heat shielding layer.

FIG. 7 illustrates an X-ray image of a multilayer structure with a composite tungsten oxide coated onto different substrates.

FIG. 8A illustrates a scanning electronic microscope (SEM) image of a multilayer structure with a composite tungsten oxide coated onto a general glass, wherein the general glass is not coated with silicon dioxide.

FIG. 8B illustrates a scanning electronic microscope (SEM) image of a multilayer structure with a composite tungsten oxide coated onto a general glass, wherein the general glass is coated with silicon dioxide.

FIG. 8C illustrates a scanning electronic microscope (SEM) image of a multilayer structure with a composite tungsten oxide coated onto a coming glass.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

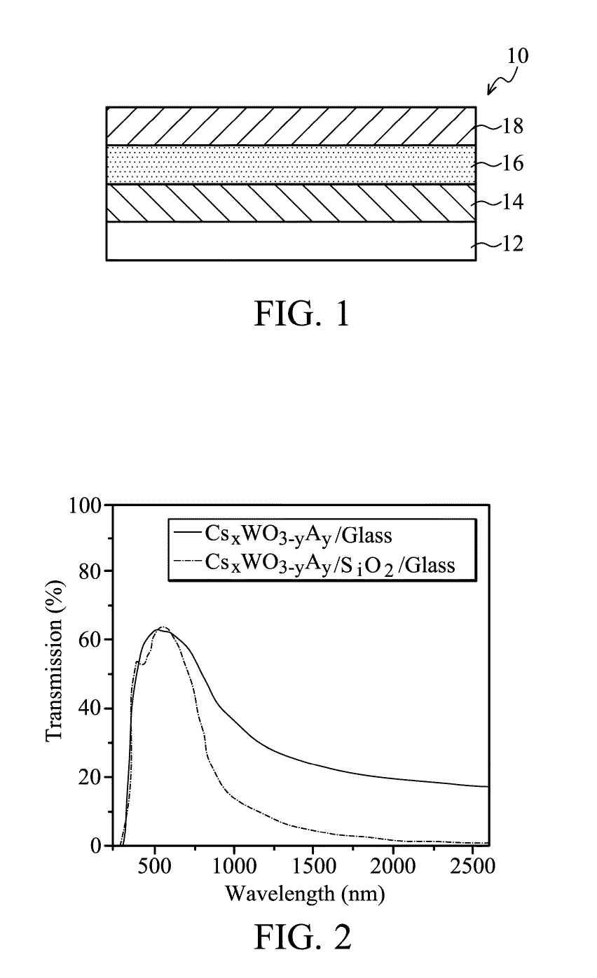

In accordance with an embodiment, the disclosure provides an infrared (IR) reflective multilayer structure 10, as shown in FIG. 1, which includes a transparent substrate 12, a barrier layer 14 disposed on the transparent substrate 12, wherein the barrier layer includes tungsten oxide-containing silicon dioxide, tungsten oxide-containing titanium dioxide, tungsten oxide-containing aluminum oxide, or a combination thereof, and a heat shielding layer 16 disposed on the barrier layer 14, wherein the heat shielding layer 16 is composed of a composite tungsten oxide, represented by Formula (I): MₓWO_{3-y}A_{y}(I), wherein M is an alkali or alkaline earth metal element, including lithium (Li), sodium (Na), potassium (K), rubidium (Rb), cesium (Cs), beryllium (Be), magnesium (Mg), calcium (Ca), strontium (Sr), barium (Ba), radium (Ra), or a combination thereof, W is tungsten, O is oxygen, A is a halogen element, and 0<x≦1, 0<y≦0.5. The transparent substrate 12 may include glass, such as a general glass or untempered glass, transparent resin, or a combination thereof. In another embodiment of the disclosure, the transparent resin may include polyester, polyimide resin, acrylic resin, epoxy resin, silicone resin, phenoxy resin, urethane resin, urea resin, acrylonitrile butadiene arylene (ABS) resin, polyvinyl butyral (PVB) resin, polyether resin, florine-containing resin, polycarbonate, polystyrene, polyamide, starch, cellulose, a copolymer thereof, a mixture thereof, or the like. The barrier layer 14 may include tungsten oxide-containing silicon dioxide, tungsten oxide-containing titanium dioxide, tungsten oxide-containing aluminum oxide, or a combination thereof, wherein the tungsten oxide is present in an amount of 0.01 to 5% based on the weight of tungsten oxide-containing silicon dioxide, for example, 0.02 to 4%. The barrier layer may have a thickness between 0.1 nm and 500 nm, for example, 200 nm. It should be noted that the thickness of the barrier layer may vary with the thicknesses of the transparent substrate. The multilayer structure 10 further includes a functional coating 18 on an outermost layer of the multilayer structure 10, wherein the functional coating 18 may include, but is not limited to, an anti-reflection coating, or a self-cleaning layer. The self-cleaning layer may be fluorine-containing silicon dioxide and the anti-reflection coating may be silicon dioxide, which is used to improve the visible light transmission of the multilayer structure 10,

In accordance with another embodiment, the disclosure provides a method for manufacturing an infrared (IR) reflective multilayer structure 10. First, a solution of tungsten oxide-containing silicon dioxide, tungsten oxide-containing titanium dioxide, or tungsten oxide-containing aluminum oxide is coated onto a transparent substrate 12 by a first wet coating process such as a spin coating, casting, bar coating,blade coating, roller coating, wire bar coating, or dip coating process, or the like. The transparent substrate 12 may include glass such as a general glass or untempered glass, transparent resin, or a combination thereof Then, a sintering process is applied to the wet-coated substrate 12 at a temperature of 300 to 650° C., for example, 500 to 650° C., for 1 to 5 minutes to form a barrier layer 14 thereon. The thickness of the barrier layer 14 is between 0.1 to 500 nm and is correlated with the speed of coating such as during a dip coating process.

Next, a composite tungsten oxide precursor solution is provided. The composite tungsten oxide may be a tungsten oxide material co-doped with at least an alkali metal or alkaline earth metal salt and a halogen salt. The composite tungsten oxide precursor may include ammonium metatungstate, ammonium orthotungstate, ammonium paratungstate, alkali metal tungsten, tungstic acid, tungsten suicide, tungsten sulfide, tungsten oxychloride, tungsten alkoxide, tungsten hexachloride, tungsten tetrachloride, tungsten bromide, tungsten fluoride, tungsten carbide, tungsten oxycarbide, or a combination thereof

The alkali metal salt may include alkali metal carbonates, alkali metal hydrogen carbonates, alkali metal nitrates, alkali metal nitrites, alkali metal hydroxides, alkali metal halides, alkali metal sulfates, alkali metal sulfites, or a combination thereof. The alkaline earth metal may include alkaline earth metal carbonates, alkaline earth metal hydrogen carbonates, alkaline earth metal nitrates, alkaline earth metal nitrites, alkaline earth metal hydroxides, alkaline earth metal halides, alkaline earth metal sulfates, alkaline earth metal sulfites, or a combination thereof. The halogen salt may include ammonium halide, alkylammonium salt, halocarbon, hydrogen halide, tungsten halide, benzene halide, halogenated aromatic, alkyl halide, or a combination thereof

The composite tungsten oxide precursor solution is adjusted to alkaline by an inorganic base to form a highly stable, highly continuous, and highly transparent precursor solution, wherein the pH value of the composite tungsten oxide precursor solution may be greater than 7, preferably between 9 and 12. The organic base may include organic amines such as dimethyl amine, trimethyl amine, piperidine, morpholino, triethyl amine, pyridine and so on. The inorganic base may include ammonia, hydroxide of alkali or alkaline earth metal, carbonate of alkali or alkaline earth metal, bicarbonate of alkali or alkaline earth metal, or the like. For example, sodium bicarbonate, potassium bicarbonate, lithium carbonate, sodium carbonate, potassium carbonate, lithium hydroxide, sodium hydroxide, potassium hydroxide, barium hydroxide, or the like.

Next, the transparent precursor solution with the adjusted pH value is coated onto the barrier layer 14 by a second wet coating process. Moreover, the formed wet film is oven dried at a temperature of about 25 to 200° C. for about 0.5 to 30 minutes.

A thermal process is performed under a reducing gas atmosphere, with gas such as hydrogen, wherein the percentage of reducing gas may be about 1 to 100% (vol). The thermal process incorporates pyrolysis with a strengthening process, which is performed for pyrolyzing the composite tungsten oxide precursor to form a heat shielding layer 16 and strengthening the transparent substrate 12. It is noted that when a general glass has been strengthened, a subsequent thermal process at a temperature over 500° C. will reduce the strength of the glass. This problem is lessened by the disclosed method, since it integrates pyrolysis and the strengthening process into a single procedure. As a result, the loss of strength due to a subsequent thermal process is hindered. The heat shielding layer 16 is composed of tungsten oxide. The thermal process is performed at a temperature of about 300 to 650° C. and one embodiment about 500 to 650° C., for about 1 to 5 minutes and one embodiment about 1 to 2 minutes. To strengthen the glass, the thermal process further includes a rapid cooling process with the temperature decreasing from 500 to 650° C. to room temperature within about 20 to 30 seconds. A tempered glass is formed by heating the glass plate to a temperature close to a softening point and then rapidly cooling the glass surface. Compressive stress is distributed at the glass surface while the tensile stress is distributed in the central layer. The tensile stress caused by an external pressure is offset by the uniformly distributed compressive stress. If the rapid cooling process is not performed during the thermal cycle, the strength of glass will not be increased since the tensile stress will not be generated at the glass surface to balance the compressive stress at the central layer.

The disclosure provides an infrared (IR) reflective multilayer structure formed by wet coating and a manufacturing method thereof. The conventional heat shielding glass formed by vacuum coating has a high cost and requires a multilayer formation. In comparison, the heat shielding layer of the disclosure requires only one single layered coating. Thus, the process is easier, and the cost is lower. Further, since the inert gas for hindering oxidation is not needed in the present disclosure, stability and durability of the glass can be improved.

In addition, this disclosure integrates pyrolysis and the strengthening process into a single procedure to form the heat shielding layer containing a composite tungsten oxide. The heat shielding layer has high insulating properties, since the heat shielding layer is composed of tungsten oxide-containing silicon dioxide, tungsten oxide-containing titanium dioxide, tungsten oxide-containing aluminum oxide, or a combination thereof, thus hindering sodium migration effect induced by pyrolysis. Thus, the heat shielding layer can be applied to a general glass.

The multilayer structure 10 may further include a functional coating 18, which may include an anti-reflection layer or a self-cleaning layer. A silicon dioxide solution can be applied to the heat shielding layer by wet coating at a room temperature to form an anti-reflection layer to increase the visible light transmission of the multilayer structure. Moreover, since a high temperature sintering process is not needed, the formation of the functional coating 18 does not affect the insulating effect of the multilayer structure 10.

The Examples and Comparative Examples are described below to illustrate the properties of the multilayer structure and a method for manufacturing the same:

### EXAMPLE 1

10 g of tetraethyl orthosilicate (TEOS) was added into 50 mL of isopropanol (IPA) and thoroughly mixed. After 3.46 g of distilled water was thoroughly mixed with 0.1N of HCl, the prepared HCl mixed solution was slowly added to the tetraethyl orthosilicate (TEOS) solution, stirred for 4 hours, and then the resultant solution was coated onto a substrate by wet coating. The coated substrate was sintered at a temperature of 550° C. for 60 minutes. 5 g of ammonium metatungstate and 1.1 g of cesium carbonate was added into 40 mL of distilled water and thoroughly mixed. The pH value of the mixture was adjusted to 12 by an NH₄OH aqueous solution. The prepared composite tungsten oxide precursor solution was coated onto a sintered general glass (SiO₂glass) by dip coating and then oven dried at a temperature of 120° C. Finally, the dried sample was subjected to 10% (vol) of H₂/Ar at 550° C. for 60 minutes for a reducing reaction. The Ultraviolet-Visible-Infrared (UV-VIS-IR) spectrum of the sample was measured and compared with Comparative Example 1. The results are shown in FIG. 2.

### COMPARATIVE EXAMPLE 1

5 g of ammonium metatungstate and 1.1 g of cesium carbonate was added into 40 mL of distilled water and thoroughly mixed. The pH value of the mixture was adjusted to 12 by an NH₄OH aqueous solution. The prepared composite tungsten oxide precursor solution was coated onto the general glass without the barrier layer (SiO₂) by dip coating and then oven dried at a temperature of 120° C. Finally, the dried sample was subjected to 10% (vol) of H₂/Ar at 550° C. for 40 minutes for a reducing reaction. The UV-VIS-IR spectrum of the sample was measured and compared with Example 1. The results are shown in FIG. 2.

FIG. 2 illustrates the infrared (IR) transmission of a multilayer structure having and not having a barrier layer. As shown in FIG. 2, after a reducing reaction was applied to the heat shielding layer (CsₓWO_{3-y}A_{y}) of the general glass without the barrier layer (SiO₂), the IR transmission was high, indicating poor insulating effect. However, after the reducing reaction was applied to the heat shielding layer (CsₓWO_{3-y}A_{y}) of the sintered general glass with the barrier layer (SiO₂/glass), the sodium migration effect was effectively hindered, resulting in reduced IR transmission and a significantly improved insulating effect.

### COMPARATIVE EXAMPLE 2

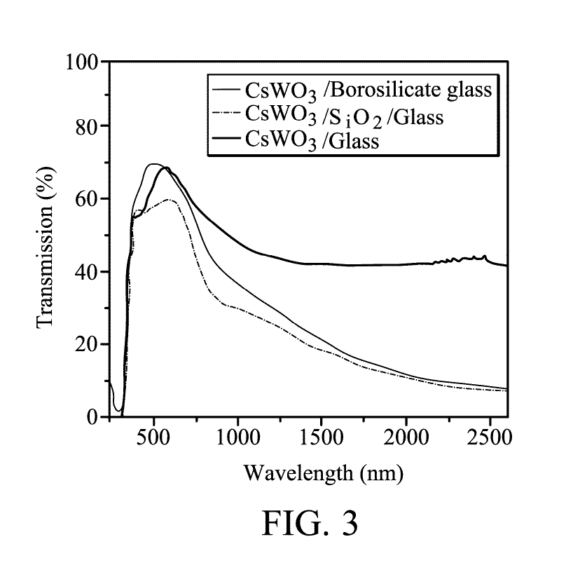

5 g of ammonium metatungstate and 1.1 g of cesium carbonate was added into 40 mL of distilled water and thoroughly mixed. The pH value of the mixture was adjusted to 12 by an NH₄OH aqueous solution. The prepared composite tungsten oxide precursor solution was coated onto a borosilicate glass without a bather layer (SiO₂) by dip coating and then oven dried at a temperature of 120° C. Finally, the dried sample was subjected to 10% (vol) of H₂/Ar at 580° C. for 5 minutes for a reducing reaction. The UV-VIS-IR spectrum of the sample was measured and compared with Example 1 and Comparative Example 1. The results are shown in FIG. 3.

FIG. 3 illustrates the infrared (IR) transmission of a multilayer structure with composite tungsten oxide on different substrates. As shown in FIG. 3, after a reducing reaction was applied to the heat shielding layer (MₓWO_{3-y}A_{y}) of the general glass with the harrier layer (SiO₂), the sodium migration effect was effectively hindered. In comparison with the heat shielding layer (MₓWO_{3-y}A_{y}) of the general glass without the barrier layer (SiO₂), lower IR transmission and superior insulating effect was observed. In addition, the visible light transmission of the heat shielding layer (MₓWO_{3-y}A_{y}) coated onto the borosilicate glass was inferior.

### COMPARATIVE EXAMPLE 3

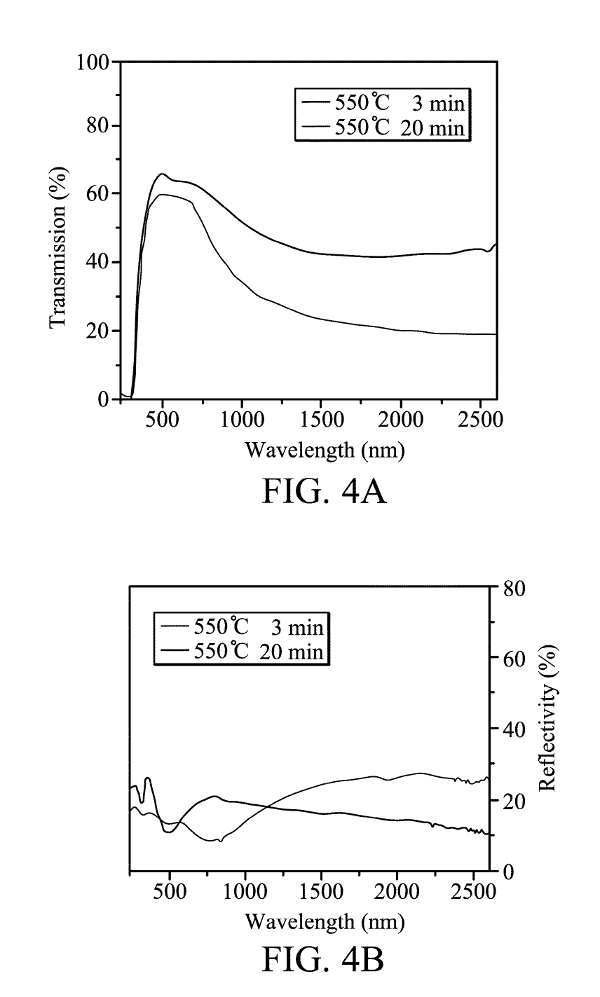

5 g of ammonium metatungstate and 1.1 g of cesium carbonate were added into 40 mL of distilled water and thoroughly mixed. The pH value of the mixture was adjusted to 12 by an NH₄OH aqueous solution. The prepared composite tungsten oxide precursor solution was coated onto the general glass without the barrier layer (SiO₂) by dip coating and then oven dried at a temperature of 120° C. Finally, the dried sample was subjected to 10% (vol) of H₂Ar at 550° C. for 3 and 20 minutes for a reducing reaction, respectively. The UV-VIS-IR spectrum of the sample was measured. The results of transmission and reflectivity are shown in FIG. 4A and FIG. 4B, respectively.

As shown in FIG. 4A and FIG. 4B, the IR insulating effect was poor when the heat shielding layer was coated onto the general glass. The sodium migration effect became more serious when the reducing time increased. Moreover, the crystal lattice structure was destroyed and resulted in improved IR transmission and reduced reflectivity. Overall, the IR insulating effect became lower when the reducing time increased.

### EXAMPLE 2

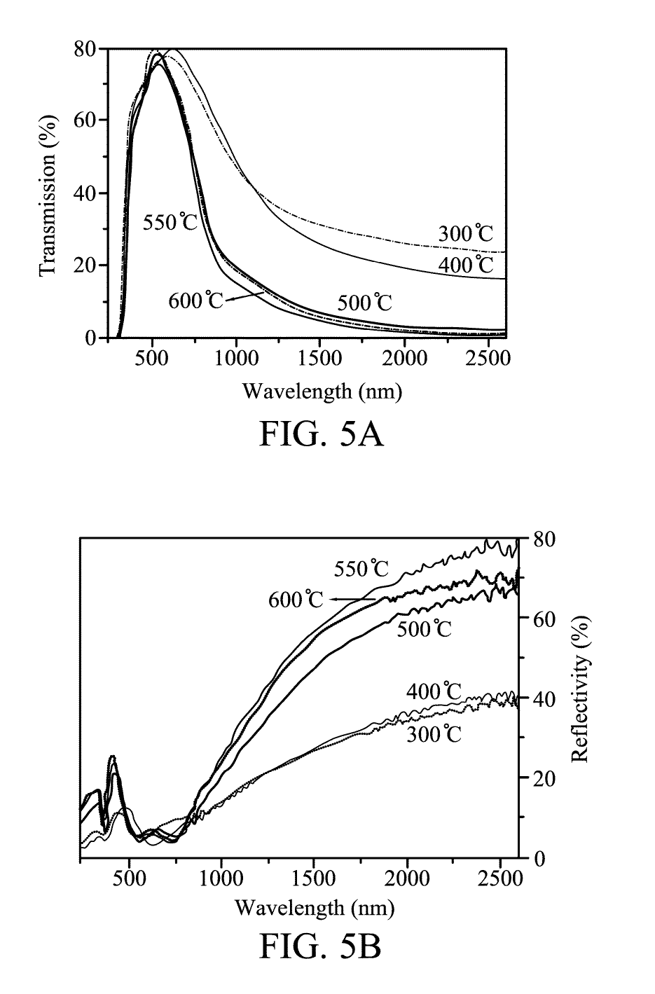

10 g of tetraethyl orthosilicate (TEOS) was added into 50 mL of isopropanol (IPA) and thoroughly mixed. After 3.46 g of distilled water was thoroughly mixed with 0.1N of HCl, the prepared HCl mixed solution was slowly added to the tetraethyl orthosilicate (TEOS) solution, stirred for 4 hours, and then the resultant solution was coated onto a substrate by dip coating. The coated substrate was sintered at varying temperatures from 300 to 600° C. for 60 minutes. 5 g of ammonium metatungstate and 1.1 g of cesium carbonate was added into 40 mL of distilled water and thoroughly mixed. The pH value of the mixture was adjusted to 12 by an NH₄OH aqueous solution. The prepared composite tungsten oxide precursor solution was coated onto a sintered glass (SiO₂/glass) by dip coating and then oven dried at a temperature of 120° C. The dried sample was subjected to 10% (vol) of H₂/Ar at 550° C. for 60 minutes for a reducing reaction. The UV-VIS-IR spectrum of the sample was measured. FIG. 5A and FIG. 5B illustrate the result of the IR insulating effect of the heat shielding layer applied a sintering process at different temperatures (300-600° C.) for 60 minutes. The results of transmission and reflectivity are shown in FIG. 5A and FIG. 5B, respectively.

As shown in FIG. 5A and FIG. 5B, the IR transmission decreased when the sintering temperature of the barrier layer (SiO₂) increased, while the reflectivity increased when the sintering temperature of the barrier layer (SiO₂) increased. Overall, the IR insulating effect improved when the sintering temperature of the barrier layer (SiO₂) increased, wherein the optimal temperature was shown to be at 550° C.

### EXAMPLE 3

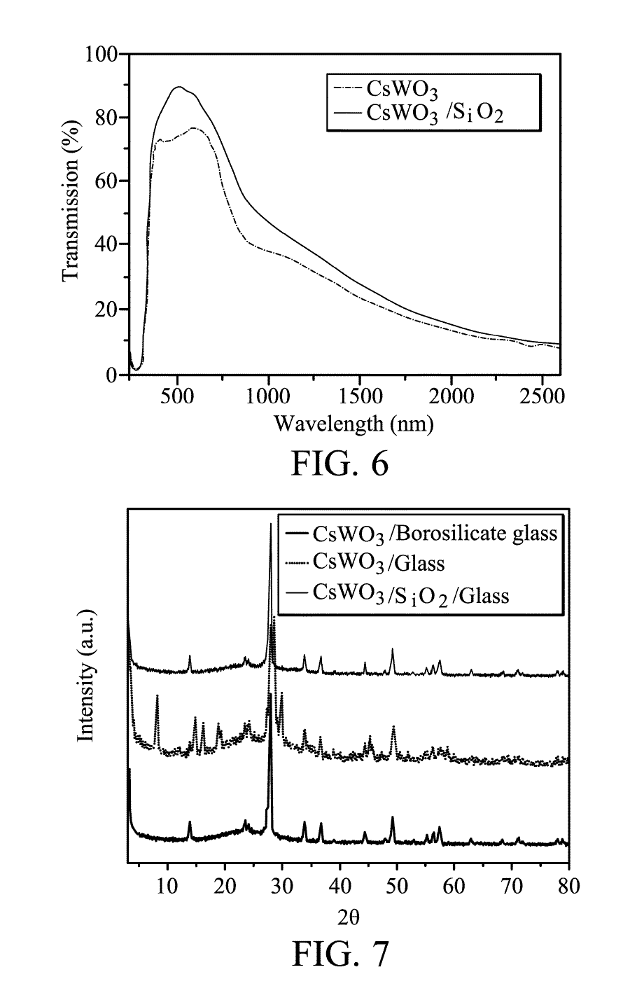

5 g of ammonium metatungstate and 1.1 g of cesium carbonate was added into 40 mL of distilled water and thoroughly mixed. The pH value of the mixture was adjusted to 12 by an NH₄OH aqueous solution. The prepared composite tungsten oxide precursor solution was coated onto a prepared glass substrate by spin coating and then oven dried at a temperature of 120° C. The dried sample was subjected to 10% (vol) of H₂/Ar at 550° C. for 60 minutes for a reducing reaction. Finally, the sample was coated with silicon dioxide (SiO₂) by dip coating and dried. The UV-VIS-IR spectrum of the sample was measured. The result of transmission is shown in FIG. 6.

As shown in FIG. 6, when silicon dioxide (SiO₂) was coated onto the heat shielding layer (MₓWO_{3-y}A_{y}), the transmission of the glass may be improved to 90% and the IR insulating effect may be generally maintained.

FIG. 7 illustrates an X-ray image of a multilayer structure with a composite tungsten oxide coated onto different substrates. As shown in FIG. 7, a peak shifted due to crystal lattice structure destruction of the composite tungsten oxide, which was directly coated onto a general glass, and showed sodium migration. In comparison, when the composite tungsten oxide was coated onto a general glass substrate which was coated with silicon dioxide (SiO₂), the sodium migration effect was effectively hindered, keeping the crystal lattice structure intact, such that the peak did not shift. Moreover, when the composite tungsten oxide was directly coated onto a borosilicate glass, the crystal lattice structure was not destroyed and the peak did not shift,

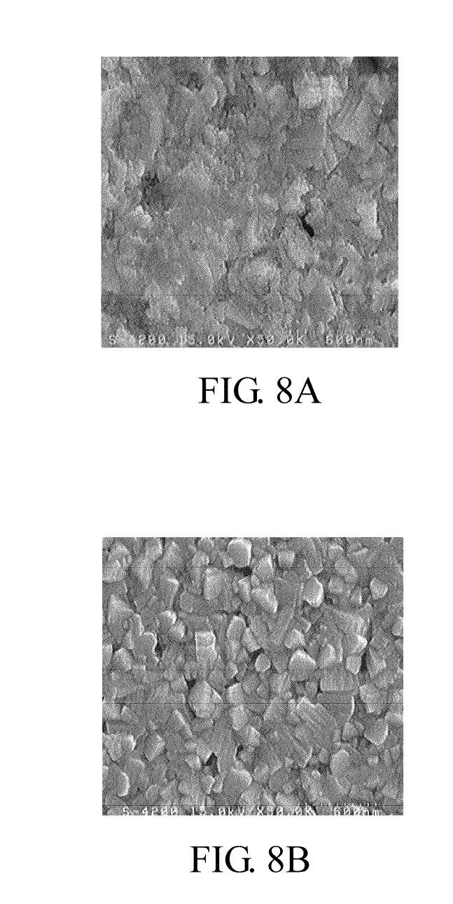

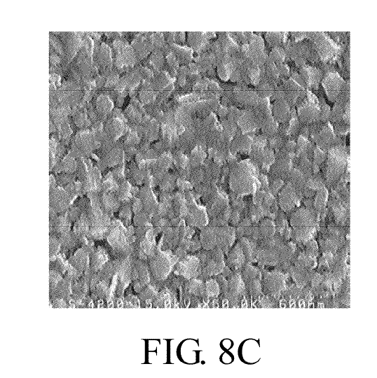

FIGS. 8A-8C illustrate the scanning electronic microscope (SEM) images of the multilayer structure with the composite tungsten oxide coated onto different glass substrates. The crystal lattice structure of the composite tungsten oxide on a general glass substrate without a barrier layer (SiO₂) was destroyed due to sodium migration, which resulted in a reduced insulating effect, as shown in FIG. 8A. In FIG. 8B, the crystal lattice structure of the composite tungsten oxide on the general glass substrate with the barrier layer (SiO₂) was kept intact since the sodium migration effect was effectively hindered by the barrier layer, and therefore, the insulating effect was elevated. FIG. 8C illustrates an SEM image of a multilayer structure with a composite tungsten oxide coated onto a corning glass substrate having a low sodium content. The sodium migration effect is insignificant due to the low sodium content; therefore, the crystal lattice structure of the composite tungsten oxide was kept intact.

The data of composite tungsten oxide coated onto the surface of different substrates is shown in Table 1. As shown in Table 1, after the barrier layer (SiO₂) was coated onto a general glass, the surface sodium content decreased from 12.37 to 4.69. That is, a general glass coated with a barrier layer (SiO₂) can hinder thermally induced-sodium migration more effectively when compared with that without the barrier layer (SiO₂).

TABLE 1

| | Reducing time | | | | |
|---|---|---|---|---|---|
| Sample/Element (mol %) | (min) | W | O | Na | Cs |
| Corning glass | 60 | 22.41 | 62.27 | 0.27 | 15.06 |
| General glass | 40 | 17.04 | 65.48 | 12.37 | 5.11 |
| General glass/SiO₂ | 20 | 13.24 | 74.68 | 4.69 | 7.38 |

### EXAMPLE 4

Barrier Layer (SiO₂—WO₃)

10 g of tetraethyl orthosilicate (TEOS) was added into 50 mL of isopropanol (IPA) and thoroughly mixed. After 3.46 g of distilled water was thoroughly mixed with 0.1 N HCl, the prepared HCl mixed solution was slowly added to the tetraethyl orthosilicate (TEOS) solution and then stirred for 4 hours. WCl₆ was added to be present in an amount of 0.2% based on the weight of silicon dioxide (SiO₂). After the above solution was thoroughly mixed, the mixture was coated onto a substrate by spin coating and then oven dried at a temperature of 120° C.

Barrier Layer (TiO₂—WO₃)

102 g of titanium butoxide was added into 331 g of ethanol (EtOH) and stirred room temperature. 51 mL of distilled water was added into 93 g of nitric acid (HNO₃) (65-70%) and 91 g of ethanol (EtOH) and thoroughly mixed. Then, the mixture was slowly added into the above titanium butoxide mixed solution and stirred at room temperature for 10 minutes until a homogeneous phase was achieved. WCl₆ was added to be present in an amount of 0.04% based on the weight of silicon dioxide (SiO₂). After the above solution was thoroughly mixed, the mixture was coated onto a substrate by spin coating and then oven dried at a temperature of 120° C.

Barrier layer (Al₂O₃—WO₃)

670 g of aluminum-tri-sec-butoxide was added into 2500 g of isopropanol (IPA) and stirred at room temperature. A chelating agent of 204 g of ethyl acetoacetate was added into the reaction bottle and stirred for more 20 minutes. After the suspension of the solution was filtered off the clean filtrate was poured into the reaction bottle. 51 g of distilled water was added into 943 mL of isopropanol (IPA) and stirred and thoroughly mixed. Then, the mixture was added into the clean filtrate and stirred for 3 hours for hydrolysis. WCl₆ was added to be present in an amount of 0.2% based on the weight of silicon dioxide (SiO₂). After the above solution was thoroughly mixed, the mixture was coated onto a substrate by spin coating and then oven dried at a temperature of 120° C. The coated substrate was sintered to a temperature of 550° C. for 60 minutes. The prepared composite tungsten oxide precursor solution was coated onto a glass with a sintered barrier layer of SiO₂ or SiO₂—WO₃ by dip coating and then oven dried at a temperature of 120° C. The dried sample was subjected to 10% (vol) H₂Ar at 580° C. for 5 minutes fora reducing reaction.

The resulting infrared (IR) reflective multilayer structure was composed of a barrier layer, a heat shielding layer, and a functional coating. The adhesiveness and the result of the wearing test of the unmodified barrier layer and the heat shielding layer were poor. In comparison, the adhesion between the modified or functionalized ba layer and heat shielding layer increased, and the result of the wearing test was about 10 times better.

| Sample | Wearing test (Loading: 500 g) |
|---|---|
| Glass/SiO₂/MₓWO_{3-y}A_{y} | 100 times |
| Glass/SiO₂—WO₃/MₓWO_{3-y}A_{y} | 1000 times |
| Glass/TiO₂—WO₃/MₓWO_{3-y}A_{y} | 500 times |
| Glass/Al₂O₃—WO₃/MₓWO_{3-y}A_{y} | 1000 times |

In summary, the disclosure provides a method for coating a barrier layer on the surface of a general glass by a wet coating process. The barrier layer has improved denseness after a thermal process is performed thereto, and is capable of protecting the composite tungsten oxide material from sodium migration induced by pyrolysis. In addition, the adhesion between the barrier layer and heat shielding layer is improved. Moreover, the heat shielding layer of the disclosure only requires one single layered coating. Thus, the process is simplified, and costs lowered, while improving the overall insulating effect. Furthermore, the silicon dioxide coating on the outermost layer of the multilayer structure enhances visible light transmission of the heat shielding layer.

While the disclosure has been described by way of example and in terms of the embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An infrared (IR) reflective multilayer structure, comprising:
a transparent substrate;
a barrier layer disposed on the transparent substrate, wherein the barrier layer comprises tungsten oxide-containing silicon dioxide, tungsten oxide-containing titanium dioxide, tungsten oxide-containing aluminum oxide, or a combination thereof; and
a heat shielding layer disposed on the barrier layer, wherein the heat shielding layer is composed of a composite tungsten oxide, represented by Formula (I):
MₓWO_{3-y}A_{y} (I)
, wherein M is an alkali metal element or alkaline earth metal element, W is tungsten, O is oxygen, A is halogen, and 0<x≦1, 0<y≦0.5.

2. The infrared (IR) reflective multilayer structure as claimed in claim 1, wherein the transparent substrate comprises glass, transparent resin, or a combination thereof.

3. The infrared (IR) reflective multilayer structure as claimed in claim 1, wherein the tungsten oxide is present in an amount of 0.01 to 5% in the tungsten oxide-containing silicon dioxide.

4. The infrared (IR) reflective multilayer structure as claimed in claim 1, wherein a thickness of the barrier layer is between 0.1 nm and 500 nm.

5. The infrared (IR) reflective multilayer structure as claimed in claim 1, wherein M comprises lithium (Li), sodium (Na), potassium (K), rubidium (Rb), cesium (Cs), beryllium (Be), magnesium (Mg), calcium (Ca), strontium (Sr), barium (Ba), radium (Ra), or a combination thereof.

6. The infrared (IR) reflective multilayer structure as claimed in claim wherein A comprises fluorine (F), chlorine (Cl), bromine (Br), iodine (I), or a combination thereof.

7. The infrared (IR) reflective multilayer structure as claimed in claim 1, further comprising a functional coating on an outermost layer of the multilayer structure, wherein the functional coating comprises an anti-reflection layer, or a self-cleaning layer.

8. The infrared (IR) reflective multilayer structure as claimed in claim 7, wherein the anti-reflection layer comprises silicon dioxide.

9. A method for manufacturing an infrared (IR) reflective multilayer structure, comprising:
performing a first wet coating process by coating a tungsten oxide-containing silicon dioxide solution, a tungsten oxide-containing titanium dioxide solution, or a tungsten oxide-containing aluminum oxide solution on a h transparent substrate, and then sintering the coated substrate to form a barrier layer thereon;
providing a solution of a composite tungsten oxide precursor, and adjusting a pH value of the solution to obtain a transparent precursor solution;
performing a second wet coating process by coating the transparent precursor solution on the barrier layer; and
performing a thermal process under a reducing gas atmosphere to strengthen the transparent substrate, and simultaneously pyrolyze the solution to form a heat shielding layer.

10. The method for manufacturing the infrared (IR) reflective multilayer structure as claimed in claim 9, wherein the sintering of the coated substrate is performed at a temperature of 300 to 650° C. for 1 to 5 minutes.

11. The method for manufacturing the infrared (IR) reflective multilayer structure as claimed in claim 9, wherein the adjusting of the pH value of the solution adjusts the value to be over 7 to form the transparent precursor solution.

12. The method for manufacturing the infrared (IR) reflective multilayer structure as claimed in claim 9, further comprising performing a drying procedure to the wet film formed after the second wet coating process.

13. The method for manufacturing the infrared (IR) reflective multilayer structure as claimed in claim 9, wherein the reducing gas is hydrogen.

14. The method for manufacturing the infrared (IR) reflective multilayer structure as claimed in claim 9, wherein the strengthening of the transparent substrate is performed at a temperature of 300 to 650° C. for 1 to 5 minutes

15. The method for manufacturing the infrared (IR) reflective multilayer structure as claimed in claim 14, wherein the strengthening of the transparent substrate further comprises a rapid cooling process, wherein the temperature rapidly decreases from 500 to 650° C. to room temperature within about 20 to 30 seconds.

16. The method for manufacturing the infrared (IR) reflective multilayer structure as claimed in claim 9, further comprising forming a functional coating on an outermost layer of the multilayer structure, wherein the functional coating comprises an anti-reflection layer, or a self-cleaning layer.

17. The method for manufacturing the infrared (IR) reflective multilayer structure as claimed in claim 16, wherein the anti-reflection layer comprises silicon dioxide.

18. The method for manufacturing the infrared (IR) reflective multilayer structure as claimed in claim 16, wherein the self-cleaning layer comprises fluorine-containing silicon dioxide.

19. The method for manufacturing the infrared (IR) reflective multilayer structure as claimed in claim 9, wherein the solution of composite tungsten oxide comprises a tungsten oxide material co-doped with at least an alkali metal salt or alkaline earth metal salt and a halogen salt.

20. The method for manufacturing the infrared (IR) reflective multilayer structure as claimed in claim 9, wherein the composite tungsten oxide precursor comprises ammonium metatungstate, ammonium orthotungstate, ammonium paratungstate, alkali metal tungsten, tungstic acid, tungsten suicide, tungsten sulfide, tungsten oxychloride, tungsten alkoxide, tungsten hexachloride, tungsten tetrachloride, tungsten bromide, tungsten fluoride, tungsten carbide, tungsten oxycarbide, or a combination thereof.
